(19) United States
(12) Patent Application Publication
(10) Pub. No.: US 2015/0172348 A1
(43) Pub. Date: Jun. 18, 2015

(54) METHOD FOR SENDING RESPECTIVELY RECEIVING A MEDIA STREAM

(71) Applicants: Thorsten Lohmar, Aachen (DE); Frederic Gabin, Bagnolet (FR)

(72) Inventors: Thorsten Lohmar, Aachen (DE); Frederic Gabin, Bagnolet (FR)

(73) Assignee: Telefonaktiebolaget L M Ericsson (PUBL), Stockholm (SE)

(21) Appl. No.: 14/372,991

(22) PCT Filed: Jan. 17, 2012
(86) PCT No.: PCT/EP2012/050647

§ 371 Date: Jul. 17, 2014

(51) Int. Cl. H04L 29/06

(52) U.S. Cl. CPC H04L 65/602; H04L 65/604

(57) ABSTRACT

A method for receiving a media stream, whereby the media stream is segmented in a plurality of consecutive segments. A Manifest file is received, whereby the Manifest file comprises an indication of media segments in a URI template manner and a start index referencing a first segment of said media stream. From the received information within the Manifest file different URIs are assembled, whereby an assembled URI references a segment of said plurality of segments and whereby assembling is based on said indication and an index, whereby the index is calculated on basis of the start index and is incremented by a predetermined value for each consecutive segment. By means of these assembled URIs said segments are received, whereby receiving is based on an identifier allowing for identifying packets of a same segment, whereby said segments are spread over a plurality of packets and each packet of a particular segment comprises said particular identifier, whereby the index is mapped to the identifier. The fetched media segment packets are reassembled to form said media stream.

### TECHNICAL FIELD

The invention relates to a method for receiving a media stream.

### BACKGROUND

So far standardized Live Video Packet Services over Mobile networks relied on RTP (Real Time Transport Protocol) for transportation of media streams also referred to as content. Since then, 3GPP/ETSI, MPEG and Open IPTV Forum organizations have defined an Dynamic and Adaptive HTTP Streaming (DASH) system. DASH was defined to transport content over the HTTP protocol. However it defines a file format that can also be transported over other file transfer protocols like e.g. FLUTE. DASH thereby describes Dynamic Adaptive Streaming over HTTP while FLUTE pertains to File Delivery over Unidirectional Transport. DASH over FLUTE describes in principle a “File Streaming” service, whereby the client re-assembles the stream out of a sequence of individually fetched files.

The difference between “HTTP streaming” and the proposed DASH Live Streaming (“File Streaming”) principle is depicted in FIG. 1.

In case of “HTTP Streaming” content, which may be provided in form of MPEG2-Transport Stream packets (MPEG2-TS), may be sent through a single pipe, e.g. a TCP pipe. After opening the HTTP/TCP pipe, e.g. by using a HTTP request/HTTP response cycle, the client receives MPEG-TS packets without sending any further HTTP request.

In case of “adaptive HTTP Streaming”, the server providing content, sub-divides the stream into a plurality of consecutive media segments, each containing a certain duration of media data (typically around 1 sec or 10 sec). A client fetches these media segments individually, i.e. sends a HTTP request for each media segment at a certain point in time, and joins the fetched media segments on the client side such that a continuous stream is formed.

DASH standard is composed of two main parts.

A first part provides for a Media Presentation Description (MPD) which shall be used by the client to derive the appropriate links to access the content.

A second part identifies the format of the content, content is meant in terms of media segments, as extensions to the ISO File Format (3 GP or MP4) and MPEG2-TS format.

The default protocol for media segments retrieval is HTTP based although other protocols may be used as well. A protocol allowing for such retrieval shall be able to uniquely identify media segments, e.g. by usage of URLs or the like.

The purpose of the MPD is to provide information relating to the characteristics of the available content versions (e.g. video resolutions, bitrates), location and timing towards a client, such that the client is enabled to fetch and playback the media segments of a particular content.

The MPD syntax is defined in XML manner. Typically the MPD file is fetched using HTTP at the start of the streaming session, but for flexibility, the MPD may also be updated/re-fetched after a predetermined time interval lapsed.

The MPD as shown schematically in FIG. 2 comprises three major components, namely Periods, Representations and Segments. Although described in the following in a hierarchical manner, it is to be understood that any appropriate format may be chosen which allows for a clear attribution of relating components.

As depicted in FIG. 2, Period elements are shown as the outermost part of the MPD. Periods typically represent larger pieces of media that shall be presented towards a user in a sequential manner.

Inside a period, multiple different encodings of the content may occur. Each alternative is called a Representation. These alternative Representations may provide for different bitrates and/or different frame rates and/or video resolutions and the like.

Finally, each Representation describes a series of segments, e.g. by using HTTP URLs. These URLs are either explicitly described in the Representation (and might therefore resemble a playlist) or the URLs are described through a template construction, which allows the client to derive a valid URL for each segment of a representation.

As said, the MPD format is flexible and can support other media container formats such as MPEG-2 TS. Even more, MPD allows also for Content play-list and/or ad-insertion functionality as periods of different content may be chained within a Representation or Periods.

The 3 GP file format and thereby also the 3 G2 and MP4 file format widely used in telecommunication systems is based on the ISO base media file format (ISO-FF). In the following we will reference 3 GP only, but assume that 3 G2 and MP4 is encompassed thereby as well. A portion of a 3 GP media stream is displayed schematically in FIG. 3.

A 3 GP segment for HTTP streaming may be an initialization segment or a media segment.

An initialization segment comprises configuration data (which may be formatted as ‘ftyp’ and ‘moov’ boxes of the file format).

A media segment resembles a concatenation of one Segment type box (‘styp’) and one or more movie fragments of media pointers and samples (‘moof’ and ‘mdat’ boxes).

Having concatenated the initialization segment with one or more media segments of the same representation shall result in a valid 3 GP file.

The 3 GP file format was extended for the specific HTTP streaming requirements. It now provides also ‘sidx’, ‘tfad’ and ‘tfdt’ boxes while the ‘styp’ box that is quite similar to the ‘ftyp’ box.

The Segment Index box (‘sidx’) provides relative timing information with respect to the period start for time recovery after seeking. The Segment Index box (‘sidx’) may also provide a list of random access points. Such information may also be conveyed as a sample flag.

The Track fragment adjustment box (‘tfad’) on the other hand provides relative timing information between the tracks for media synchronization.

The Track Fragment Base Media Decode Time (‘tfdt’) Box provides the decode time of the first sample in the track fragment for media synchronization.

These boxes, i.e. ‘sidx’, ‘tfdt’ and ‘tfad’, are optional.

It is known that old stylish players often discard ‘ftyp’ boxes.

A feature of the proposed adaptive HTTP streaming is that media segments shall be identical to all users. Adaptive Manner is obtained by providing the client with the possibility to switch between segments of alternative representations.

This property makes 3 GP-DASH HTTP cache and Content Delivery Network (CDN) friendly, as media segments may easily be cached for a plurality of user. The media segments, uniquely identified by its URL can then be provided by intermediate HTTP Proxy/Caches in the same way as any other Web Content.

Another feature of HTTP Streaming in 3GPP is that the codecs defined for other streaming solutions such as 3GPP PSS streaming may be reused, thereby eliminating the need to provide additional codecs.

Also in other areas such as in IPTV (Internet Protocol Television), similar concepts are likely to be employed, as e.g. Open IPTV Forum (OIPF) adopted a like specification as part of their Release 2 which was published in September 2010. The MPD syntax and semantic are re-used showing only minor adaptations.

Also an extension allowing support of media segments in MPEG2 Transport Stream (MPEG2-TS) format was specified. The MPEG2-TS extensions offered by OIPF is aligned to the one offered by the 3 GP media segments showing only minor adaptations. The MPD may indicate using e.g. the MIME types “video/mpeg” or “video/mp2 t” that the format of the media segments is MPEG2-TS.

The OIPF MPEG-2 TS format may be understood as a subset of the full TS format. Hence, it is possible to form a compliant MPEG2-TS stream by joining the media segments fetched by the client.

The Program Specific Information (PSI) tables may be comprised in an initialization segment and/or in one or more media segments.

Each media segment shall start with a random access point. All media representations shall be time aligned allowing for a simplified switching as well as for bitrate adaptation. MPEG2-TS random_access_indicator fields may be used to signal random access points within one or more media segments, thereby allowing for a simplified trickplay and/or seeking operations on the client side.

DASH specifications are now available for server and client implementers with 3 GP and MPEG2-TS file formats.

Even though several benefits are offered as of today by the above described set-ups, there are major problems to be solved.

MBMS File Delivery which is also described as MBMS Download is not designed for Live Video distribution. Live Video distribution, as well as other live services, is relying on real time protocols such as RTP.

One could envisage a change towards a “DASH over FLUTE” design. However, such a design requires each media segment to be announced by a new File Delivery Table (FDT) instance. An FDT Instance thereby shall comprise the File Name and the respective FEC configuration (e.g. the Symbol Size and the Content Length) for the respective media segment. The file name contained in the FTD Instance is associated with a Transport Object ID, which is an integer number. This Transport Object Identifier is to be included in each packet belonging to the respective media segment. In addition each packet comprises a sequence number, often referred to as FEC Payload ID, which is used to identify the sequence of packets within a segment.

To illustrate this issue, we will refer in the following to FIGS. 4 and 5 pertaining to the process of DASH over MBMS.

There, the MPD comprises an URL template, which shall describe a valid URL construction by replacing a well defined sequence of characters (here $Index$) by characters of an integer number (here “10” to “12), which is an index. The range of the index is also given in the MPD. A default start index may be “1”.

A media client may use the template http://www.example.com/FIFA_{—}2 min-$Index$0.3 gs and the index to construe valid URIs for the media segments. If the index is 10, then a valid URI for a media segment can be http://www.example.com/FIFA_{—}2 min-10.3 gs.

A property of the FLUTE protocol thereby is to allow for assigning each file URI, e.g. http://www.example.com/FIFA_{—}2 min-10.3 gs, a Transport Object ID (TOI), e.g. 10 (See FIG. 4). Note, a file referenced by the URI may still be fragmented into several packets, e.g. UDP packets, and the TOI is used by the media client to collect FLUTE packets belonging to the same file. This may be accomplished since all packets with the same TOI are held to be part of the same file.

FIG. 5 illustrates a transmission of a DASH segment stream over FLUTE. There, each Media Segment, e.g. FIFA-seg003.3 gs is announced within a simplified displayed FLUTE FDT instance and is assigned a single Transport object ID, i.e. in the shown example the TOI 21 is assigned to a file being named FIFA-seg003.3 gs (simplified Content-Location) while the TOI 22 is assigned to file URI FIFA-seg004.3 gs. Furthermore, each FLUTE FDT Instance indicates FEC parameters such as FEC Symbol Size, FEC Encoding and other FEC Info, File Size, as well as content type and exact content location as shown in FIG. 4. After the FDT Instance, the respective “UDP/Flute” packets of said File “FIFA-seg003.3 gs” may be received and reassembled. In between a sequence of packets, an FDT Instance may be repeated as shown in FIG. 5 by a repetition of “FDT Inst #x” packet, A drawback is that a FLUTE receiver will discard the entire segment, if the FDT instance corresponding to said instance is not received or if the FDT instance is corrupt, since the FLUTE receiver cannot decode the media segment without a proper FEC configuration as well as missing content location respectively the correct type of content (MIME Type) and/or File size which is provided within FDT instance. Such a discarding will lead to a quality of the service being perceived as poor thereby diminishing the overall benefit of a common approach allowing the re-usage of known codecs and delivery mechanism and thereby minimizing the time to market as well overall software development and maintenance costs.

### SUMMARY

It is an object to obviate at least some of the above disadvantages and provide an improved method for sending respectively receiving a media stream as well as improved devices therefore.

Therefore, the invention proposes a method for receiving a media stream, whereby the media stream is segmented in a plurality of consecutive segments. In the beginning a Manifest file is received, whereby the Manifest file comprises an indication of media segments in a URI template manner and a start index referencing a first segment of said media stream. From the received information within the Manifest file different URIs are assembled, whereby an assembled URI references a segment of said plurality of segments and whereby assembling is based on said indication and an index, whereby the index is calculated on basis of the start index and is incremented by a predetermined value for each consecutive segment. By means of these assembled URIs said segments are received, whereby receiving is based on an identifier allowing for identifying packets of a same segment, whereby said segments are spread over a plurality of packets and each packet of a particular segment comprises said particular identifier, whereby the index is mapped to the identifier. The fetched media segment packets are reassembled to form said media stream.

The invention proposes also a method for providing said media streams in the above described manner as well as respective apparatuses allowing for executing the respective method.

### BRIEF DESCRIPTION OF THE DRAWINGS

In the following, the invention will be further detailed with reference to the accompanying figures, in which

FIG. 1 shows schematically a comparison of a traditional media stream and a segmented media stream;

FIG. 2 shows schematically the general arrangement of a media presentation description;

FIG. 3 shows schematically a typical arrangement of a 3 gp format based http streaming of segments;

FIG. 4 shows schematically the design principle of prior art allowing for identification of individual URIs of a media stream;

FIG. 5 shows schematically a transmission of DASH segments over FLUTE;

FIG. 6 shows schematically an arrangement of devices according to the invention within a system allowing for taking benefit of the invention;

FIG. 7 shows a flowchart illustrating aspects of client according to embodiments of the invention, and

FIG. 8 shows a flowchart illustrating aspects of a server according to embodiments of the invention.

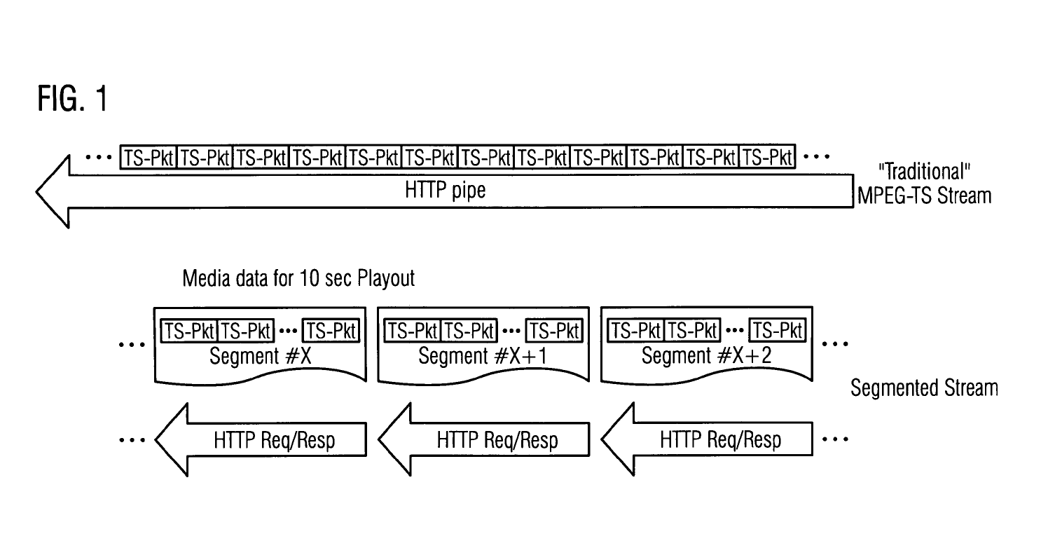

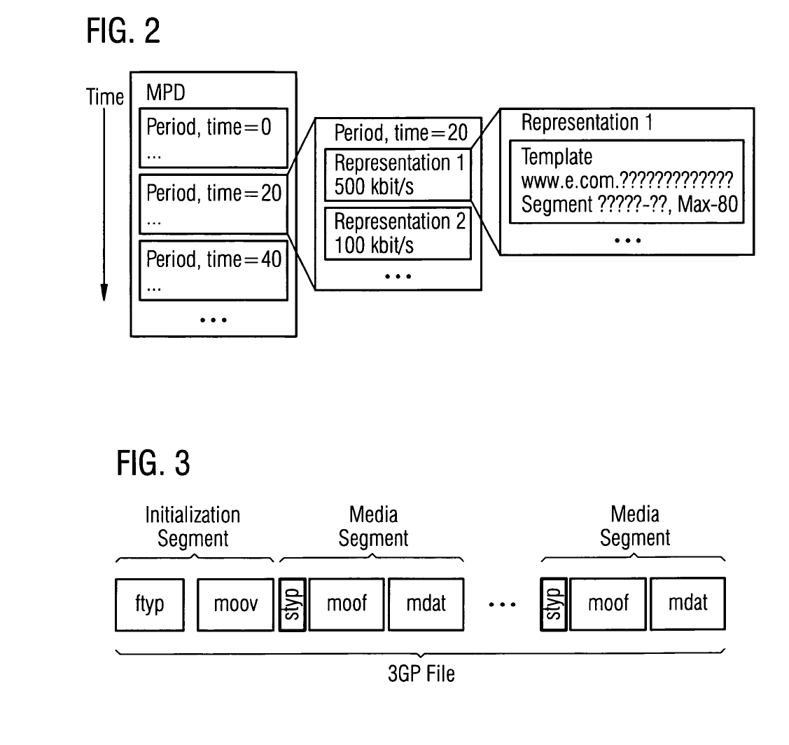

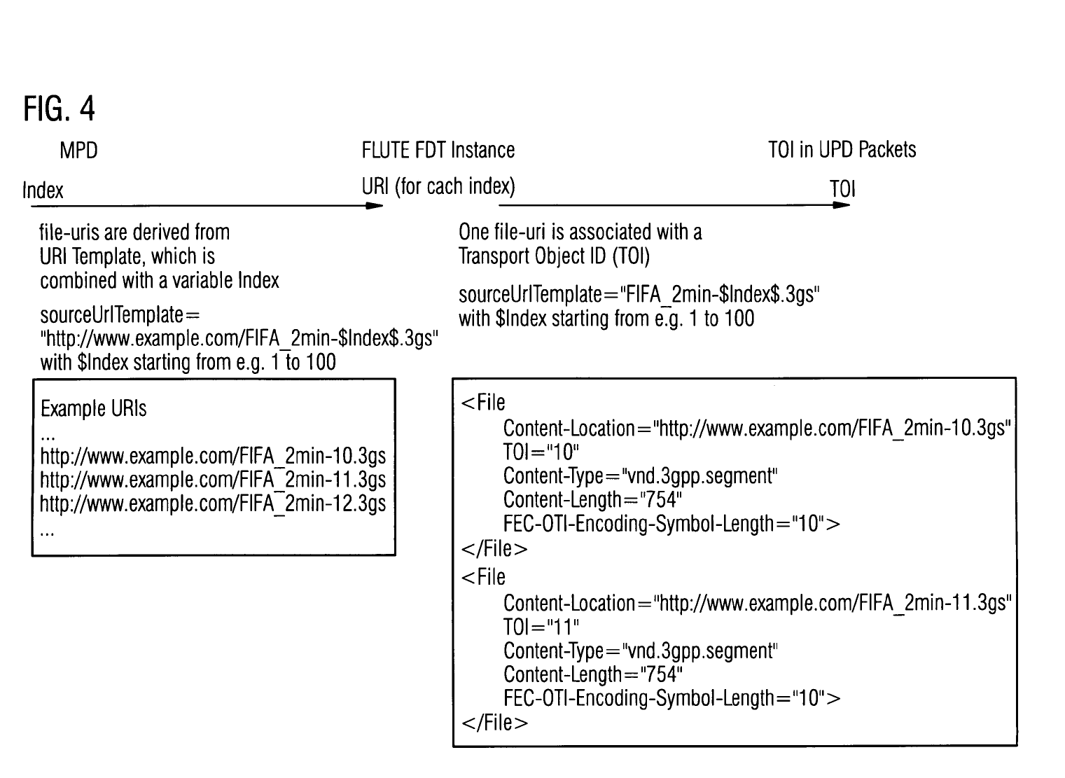

### DETAILED DESCRIPTION

Before embodiments of the invention are described in detail, it is to be understood that this invention is not limited to the particular component parts of the devices described or steps of the methods described as such devices and methods may vary. It is also to be understood that the terminology used herein is for purposes of describing particular embodiments only, and is not intended to be limiting. It must be noted that, as used in the specification and the appended claims, the singular forms “a,” “an” and “the” include singular and/or plural referents unless the context clearly dictates otherwise.

The inventors noted that plural consecutive files of a file sequence provide for almost same size and/or duration. As a consequence most of the FEC parameters of this similar sized and/or offering similar duration will also be similar. This may be true for some or even all files of a stream. Furthermore, the inventors noted that the MPD file as well as the FDT Instances each comprises—at least in part—similar information while other information is provided only within FDT Instances, such as File Size and FEC parameters and File Size.

The invention proposes to transport media segments, e.g. ISO-FF or MPEG2-TS or the like, in a direct manner, e.g. via an ALC (Asynchronous Layered Coding) protocol as defined by IETF, thereby eliminating the need of the IETF FLUTE protocol. To allow for such a transport, information which is similar is arranged such that it gets identical, while static information which was traditionally transported in a FLUTE FDT Instance is moved towards the MPD. Variable information may be transported by a different means, i.e. it may be coded into a header, e.g. as extension.

The invention allows therefore for an increased robustness.

The MPD can describe the sequence of media segment URIs in form of a URI template with a separate index. The MPD comprises a start index and may optionally also comprises an end-index. Such an end-index may be known in advance, e.g. in case of a know end-time of a live session. The client may form media segment URIs by combining an URI template with an index.

An Example Template may be “http://server/path/seg$Index$0.3 gs”, where the sequence “$Index$” is to be replaced by an index, e.g. an integer value of the index. By way of Example, if the value of $Index$ is 9 then the resulting URI would be “http://server/path/seg9.3 gs”

The FLUTE protocol extended the ALC (Asynchronous Layered Coding) with generic file delivery functions. FLUTE in particular provided the functionality to associate file properties like File Name and MIME Type to the ALC/LCT TOI element (Transport Object IDs). Hence, each UDP packet comprises the TOI value of the transport object, i.e. the file, to which it belongs.

FLUTE may also provide a time-out mechanism, which allows a client to remove a TOI to file association.

An FDT entry may comprises inter alia
TOI (Entry)
Expiration time for the association
File Name (Content-Location)
MIME Type (Content-Type)
Content-Length
FEC symbol Size
FEC Encoding ID
Source Block Length
Other FEC OTI parameters

A capable client as enabled by the invention, e.g a “DASH over MBMS” capable client, may directly create a Media Segment URI by using an identifier allowing for identifying packets of a same segment, such as an ALC TOI value, as index for the Media Segment URI creation. The identifier may be used in a direct manner as $Index$ or may be used within a predetermined scheme such as within a predetermined calculation scheme. I.e. the $index$ is aligned to the ALC TOI scheme, where the index typically starts with 1. In doing so, the index directly maps to both the MPD segment index and the ALC TOI. The MPD may also comprise the Content Type (MIME Type) as this is typically static data for the segments of a stream, respectively its packets. An MPD provided towards a client as enabled by the invention shall comprise a dedicated “broadcast” representation (or Adaptation Set), which the client may use when receiving media segments over MBMS.

Such a Broadcast Representation shall comprise a FEC Encoding ID (and may optionally also comprise a FEC Instance ID) allowing to describe a used FEC scheme. Note even a NO-CODE FEC is a valid FEC scheme comprising Encoding ID 0. The broadcast representation in the MPD may also comprise a FEC Symbol Size and may further comprise other FEC Scheme specific information on a need-basis. FEC Scheme specific information may pertain to the number of sub-blocks and/or the number of sub-symbols per encoding symbol.

In case media delivery requires a time alignment across different representations, media segments shall provide for the same duration of media play time. As a consequence, the media segments may vary in size due to the nature of video typically showing a Variable Bit Rate.

In this case the object length or number of encoding symbols shall be provided for each file, e.g. an ALC Transport Block. For this purpose the information may be provided within a header, such as a LCT header extension, allowing for carrying the necessitated information, e.g. as part of an ALC header. Such a header may be provided along each packet.

In case media delivery allows for constant size media segments, the play time of each media segment will typically be different, i.e. if media segments are of constant size (in Byte) then the media play time provided by each segment typically varies.

In this case the file size or the number of source symbols may be provided in the MPD.

To enable backward compatibility with existing FLUTE receivers, it may be envisaged that a Broadcast-Multicast-Service Centre (BM-SC) as Server offering such enhanced services may still create valid FDT instances and mark as TOI 0. Since the first media segment of a media stream start with TOI=1 no negative interaction is to be expected.

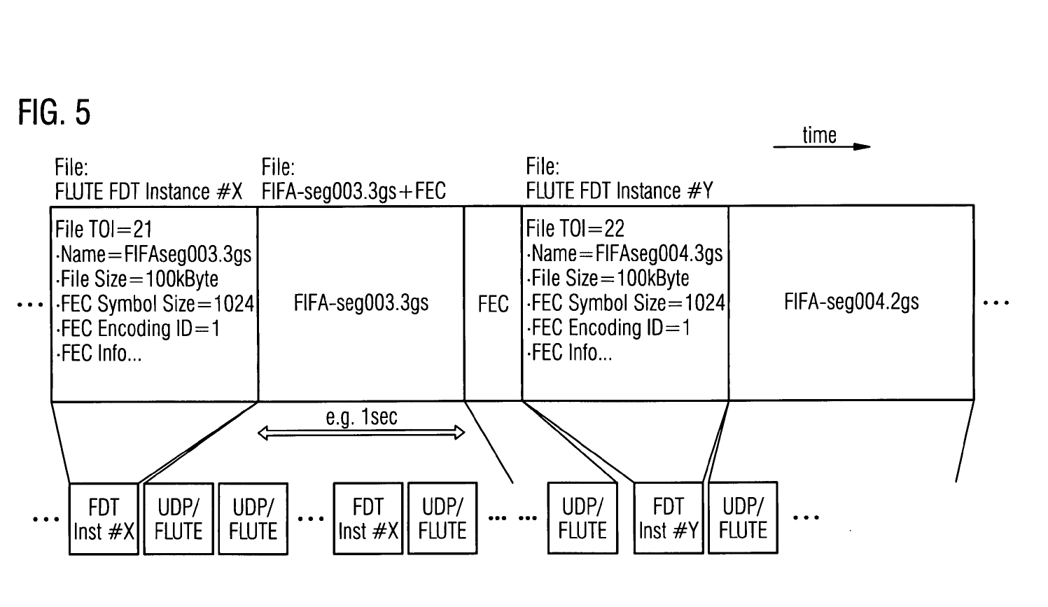

To enable MPD updates within a media session, e.g. like it is indicated in FIG. 5 where a second FDT INST#X is included while the stream of UDP/Flute packets is transmitted, it may be envisaged that an updated MPDs shall be delivered separately, e.g. in a separate channel, e.g. another FLUTE/ALC channel, e.g. by using a different Transport Session Identifier TSI in the FLUTE/ALC headers, and/or as a different (FLUTE) session, e.g. by using a different UDP port. Obviously, even though the term “update” is used, the MPD update may also be just a copy of a previously sent MPD.

An example MPD enabling “optimized DASH over MBMS” is shown below. This MPD allows for a combination of template URI construction with the information relating to FLUTE FDT Instance. This construction eliminates the need to send these FLUTE FDT Instances in separate messages, and thereby the invention provides an advantageous scheme allowing for a more reliable transport.

Hence, an MPD according to the invention comprises also a template allowing for a direct ALC Transport Object identification and file URI association. For backward compatibility, the template may be arranged such that it also allows for classical FLUTE Transport Object identification and file URI association.

In the following an example MPD showing features according to the invention is given. The example below shows an MPD implementation example with time aligned media segments.

```
<MPD xmlns=″urn:3GPP:ns:PSS:AdaptiveHTTPStreamingMPD:2009″ availabilityStartTime=″2010-
10-11T13:50:44Z″ availabilityEndTime=″2010-10-11T16:50:44Z″
timeShiftBufferDepth=″PT1M0.00S″ type=″Live″ minBufferTime=″PT10.00S″>
<Period segmentAlignmentFlag=″true″>
  <Representation bandwidth=″128000″ mimeType=″video/3gpp″ >
    <SegmentInfo duration=″PT10S″ baseURL=″mt500″>
      <InitialisationSegmentURL sourceURL=″fifa128seg_i.3gp″/>
      <UrlTemplate sourceURL=″$Index$.3gs″/>
    </SegmentInfo>
  </Representation>
  <Representation bandwidth=″512000″ mimeType=″video/3gpp″>
    <SegmentInfo duration=″PT10S″ baseURL=″mt1000″>
      <InitialisationSegmentURL sourceURL=″fifa512seg_i.3gp″/>
      <UrlTemplate sourceURL=″$Index$.3gs″/>
    </SegmentInfo>
  </Representation>
  <Representation bandwidth=″512000″ mimeType=″video/3gpp″ mbms==″true″>
    <MbmsReception>
      <bearer sdp=”http://example.com/link/del.sdp” />
      <fec fecId=”1” symLen=”135” schemeInfo=”AAEBBA==”>
    </MbmsReception>
    <SegmentInfo duration=″PT10S″ baseURL=″mt1000″>
      <InitialisationSegmentURL sourceURL=″fifa512seg_i.3gp″/>
      <UrlTemplate sourceURL=″$Index$.3gs″/>
    </SegmentInfo>
  </Representation>
</Period>
</MPD>
```

The MPD shows a hierarchical arrangement of information. A first information is the start index information given in the field availabilityStartTime=“2010-10-11T13:50:44 Z”. Also an optional end index may be provided in another field availabilityEndTime=“2010-10-11T16:50:44Z”. Further parameters pertaining to all representations may also be given, e.g. information pertaining to the buffer and/or the type of media.

The exemplary MPD comprises three Representations. Here, the first two representations

<Representation bandwidth=“128000” mimeType=“video/3 gpp”> and <Representation bandwidth=“512000” mimeType=“video/3 gpp”> describe a unicast reception of the media segments using HTTP, whereby the first representation and the second representation are differing from one another in the necessary bandwidth and as a consequence provide also for different baseURLs.

The third representation <Representation bandwidth=“512000” mimeType=“video/3 gpp” mbms==“true”> includes an attribute named “mbms”, which shall indicate an mbms reception of the media segments, i.e. multicast or broadcast reception of the media segments.

Within said third representation there is a section <MbmsReception> detailing parameters for broadcast/multicast delivery. It comprises an element named bearer with its sdp attribute references towards an SDP file detailing the delivery session description. The SDP file may describe a FLUTE session (backward compatibility) or may describe a direct session on MBMS, such as an ALC session on MBMS.

Alternatively or in addition, one may also directly include these parameters from the SDP file into the MPD. In particular the TMGI (Temporary Mobile Group Identifier i.e. MBMS bearer id), the IP Multicast address, the UDP destination port and the TSI information may be provided.

The element fec contains those FEC parameters, which are applicable for all media segments, i.e. which are static. These FEC parameters are in particular the fec-id, identifying which FEC code shall be used, symbol size (symLen) and the scheme specific information, e.g. number of source blocks and sub blocks. These FEC parameters are to be used for all media segments.

The file size or the number-of-source-symbols may be provided within a header, such as a LCT extension header, to the client.

In case the file size is provided the client calculates the number-of-source-symbols as ceil (file-size/symbol size). The last symbol may be padded to a full symbol during FEC decoding.

Depending on the required degree of robustness, this header may be provided once at the beginning or it may be provided several times within the delivery.

In the following another example MPD showing features according to the invention is given:

Media delivery also offers the possibility to use size aligned media segments. Then, all media segments are (approximately) of the same size. The amount of carried time typically varies from segment to segment, since the multimedia content is likely Variable Bit Rate encoded.

These size aligned segments may also be denoted as byte aligned segments. The segment duration may be carried explicitly or implicitly within the media segment.

E.g. in case of ISO-FF, some tables (called boxes) carry decoding timing information for each segment. In case of MPEG TS, the DTS and PTS (Decoding and Presentation timestamps) carry timing information.

Thus, as this segment duration may be derived from this information which is provided anyhow, there is no need for providing the information within a header as described before with respect to time aligned segments.

The example below shows another MPD implementation example with size aligned media segments.

```
<MPD xmlns=″urn:3GPP:ns:PSS:AdaptiveHTTPStreamingMPD:2009″ availabilityStartTime=″2010-
10-11T13:50:44Z″ availabilityEndTime=″2010-10-11T16:50:44Z″
timeShiftBufferDepth=″PT1M0.00S″ type=″Live″ minBufferTime=″PT10.00S″>
<Period segmentAlignmentFlag=″true″>
  <Representation bandwidth=″128000″ mimeType=″video/3gpp″ >
    <SegmentInfo duration=″PT10S″ baseURL=″mt500″>
      <InitialisationSegmentURL sourceURL=″fifa128seg_i.3gp″/>
      <UrlTemplate sourceURL=″$Index$.3gs″/>
    </SegmentInfo>
  </Representation>
  <Representation bandwidth=″512000″ mimeType=″video/3gpp″ >
    <SegmentInfo duration=″PT10S″ baseURL=″mt1000″>
      <InitialisationSegmentURL sourceURL=″fifa512seg_i.3gp″/>
      <UrlTemplate sourceURL=″$Index$.3gs″/>
    </SegmentInfo>
  </Representation>
  <Representation bandwidth=″512000″ mimeType=″video/3gpp″ mbms=”true”>
    <MbmsReception>
      <bearer sdp=”http://example.com/link/del.sdp” />
      <fec fecId=”1” symLen=”135” schemeInfo=”AAEBBA==” noSym=1000>
    </MbmsReception>
    <SegmentInfo duration=″PT10S″ baseURL=″mt1000″>
      <InitialisationSegmentURL sourceURL=″fifa512seg_i.3gp″/>
      <UrlTemplate sourceURL=″$Index$.3gs″/>
    </SegmentInfo>
  </Representation>
</Period>
</MPD>
```

The MPD shows a hierarchical arrangement of information. A first information is the start index information given in the field availabilityStartTime=“2010-10-11T13:50:44 Z”. Also an optional end index may be provided in another field availabilityEndTime=“2010-10-11T16:50:44Z”. Further parameters pertaining to all representations may also be given, e.g. information pertaining to the buffer and/or the type of media.

The exemplary MPD comprises three Representations. Here, the first two representations <Representation bandwidth=“128000” mimeType=“video/3 gpp”> and <Representation bandwidth=“512000” mimeType=“video/3 gpp”> describe a unicast reception of the media segments using HTTP, whereby the first representation and the second representation are differing from one another in the necessary bandwidth and as a consequence provide also for different baseURLs.

The third representation <Representation bandwidth=“512000” mimeType=“video/3 gpp” mbms==“true”> includes an attribute named “mbms”, which shall indicate an mbms reception of the media segments, i.e. multicast or broadcast reception of the media segments.

Within said third representation there is a section <MbmsReception> detailing parameters for broadcast/multicast delivery. It comprises an element named bearer with its sdp attribute references towards an SDP file detailing the delivery session description. The SDP file may describe a FLUTE session (backward compatibility) or may describe a direct session on MBMS, such as an ALC session on MBMS.

Alternatively or in addition, one may also directly include these parameters from the SDP file into the MPD. In particular the TMGI (Temporary Mobile Group Identifier e.g. MBMS bearer id), the IP Multicast address, the UDP destination port and the TSI information may be provided.

The element fec contains those FEC parameters, which are applicable for all media segments, i.e. which are static. These FEC parameters are in particular the fec-id, identifying which FEC code shall be used, symbol size (symLen) and the scheme specific information, e.g. number of source blocks and sub blocks. These FEC parameters are to be used for all media segments.

The element fec comprises another attribute named “noSym”, which indicates a number of source symbols for each media segment. A Media Client may calculate the source block size as noSym*symLen. Since a Source block, i.e. a segment, shall be of exact same length it is not necessary to transmit Padding information of the last packet in case a packet is not completely used.

When packets are received, the packets of a segment are identified by an identifier. This identifier is arranged such that it maps to the index referencing a Media Segement. E.g. if an ALC based delivery is used, the Transport Object Identifier TOI may be used directly as a reference towards the index of a segment.

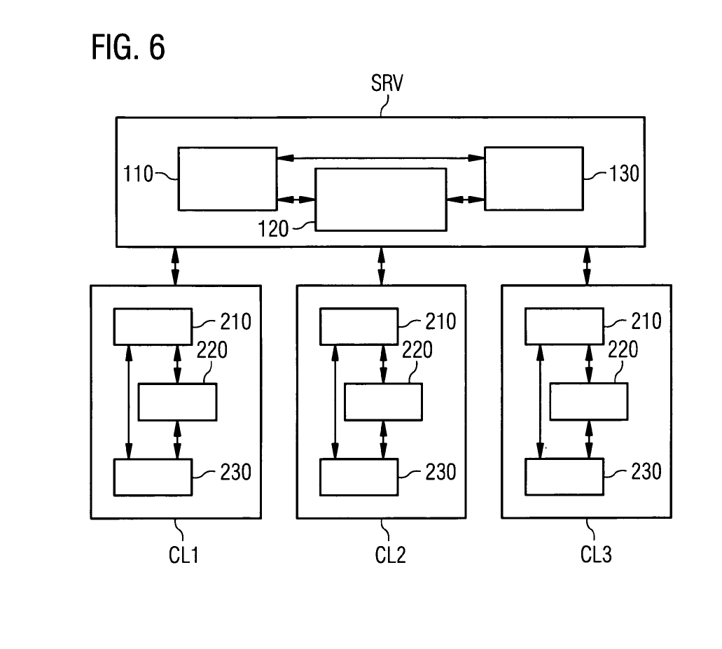

A system according to the invention is shown in FIG. 6. There a server SRV comprises inter alia a CPU 110, an I/O unit 120 and a memory 130 while other hardware such as hard disks or the like is not shown. The CPU 110 is adapted to control the I/O unit 120 and thereby is able to send and receive messages while providing media stream services. The memory 130 may store the respective application programs for execution and/or it may store one or more media stream segments to be delivered. In particular the CPU 110 is operable to send MPDs according to the invention, thereby allowing a client, such as exemplary clients CL1, CL2, CL3 to fetch respective media segments of a respective media stream. A client CL1, CL2, CL3 and the server are arranged such that they may communicate by means of their respective I/O units which each other using a communication network such as a mobile telecommunication network. An example communication network may be a LTE, UMTS or EDGE based network known in the art as well as any appropriate predecessor to be developed. Furthermore, the server SRV may also be located within a broadcasting system such as a television broadcasting system, whereby the broadcast system may or may not provide a backchannel towards individual clients, e.g. via another wireless or wirebased communication system.

A client CL1, CL2, CL3 comprises inter alia a CPU 210, an I/O unit 220 and a memory 230 while other hardware such as hard disks or the like is not shown. The CPU 210 is adapted to control the I/O unit 220 and thereby is able to send and receive messages while providing media stream services. The memory 230 may store the respective application programs for execution and/or it may store one or more media stream segments to be assembled. In particular the CPU 210 is operable to receive MPDs according to the invention, thereby allowing the client CL1, CL2, CL3 to fetch respective media segments of a respective media stream. An assembled media stream or portions thereof may then be provided towards the user by a respective media player which may also be embodied as an application stored in memory 230 and being executed by the CPU 210. Furthermore, the clients CL1, CL2, CL3 may also be located within a broadcasting system such as a television broadcasting system, whereby the broadcast system may or may not provide a backchannel towards a providing server SRV, e.g. via another wireless or wirebased communication system.

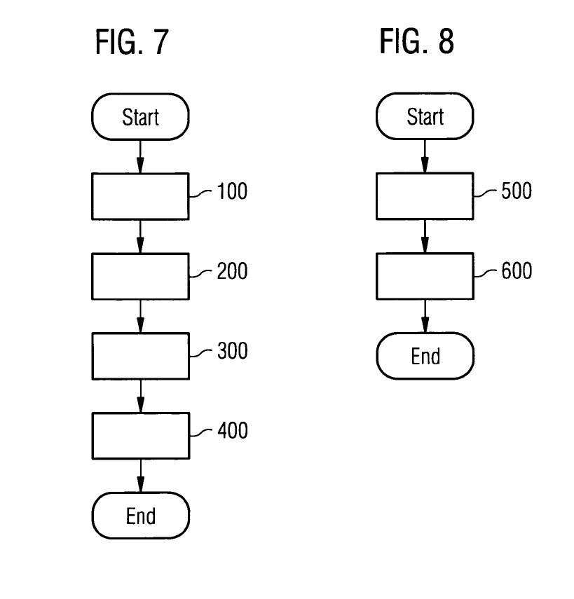

The Clients CL1, CL2, CL3 may be enabled to execute a method as highlighted in FIG. 7.

A client CL1, CL2, CL3 receives in step 100 a Manifest file, whereby the Manifest file o comprises an indication of media segments in a URI template manner, a start index referencing a first segment of said media stream.

In a step 200, the client CL1, CL2, CL3 assembles from the received Manifest file different URIs, whereby an assembled URI references a segment of said plurality of segments, whereby assembling is based on said indication and an index, and o whereby the index is calculated on basis of the start index and is incremented by a predetermined value for each consecutive segment.

In a step 300, the client CL1, CL2, CL3 receives said segments by means of the assembled URIs, whereby fetching is based on an identifier allowing for identifying packets of a same segment, whereby said segments are spread over a plurality of packets and each packet of a particular segment comprises said identifier, whereby the index is mapped to the identifier, Although the terminology of receiving is used, the process involved may be passive or active.

In a step 400, the client CL1, CL2, CL3 reassembles said segments to form said media stream.

Once all segments are received and provided towards the user or in case of a severe malfunction or on user request, the method ends.

The Server SRV may be enabled to execute a method as highlighted in FIG. 8.

A Server SRV provides in a step 500 a Manifest file, whereby the Manifest file comprises an indication of media segments in a URI template manner, a start index referencing a first segment of said media stream, whereby the Manifest file allows for assembling from the received Manifest file different URIs, whereby an assembled URI references a segment of said plurality of segments, whereby assembling is based on said indication and an index, whereby the index is calculated on basis of the start index and is incremented by a predetermined value for each consecutive segment,

In a step 600, the server SRV provides said segments by means of the assembled URIs, whereby providing is based on an identifier allowing for identifying packets of a same segment, whereby said segments are spread over a plurality of packets and each packet of a particular segment comprises said identifier, whereby the index is mapped to the identifier, thereby allowing for a reassembling said segments to form said media stream. Although the terminology of providing is used, the process involved may be passive or active.

In an embodiment of the invention it may be foreseen that the index is a Transport Object Identifier, e.g. the Transport Object Identifier of an ALC protocol.

In another embodiment of the invention it may be foreseen that the Manifest file MPD comprises an end index. This may be used e.g. in case of a known end-time.

According to a further embodiment the stream is provided in a unicast or broadcast or multicast manner. Allowing for different delivery types allows for a simplified server and client architecture.

According to yet another embodiment the segments are of substantial same size and/or of substantial same duration.

In case of segments of substantial same size, no further information regarding file-size or number of symbols is required but a reference allowing for calculate based on other information timing information. Therefore, in case of size aligned segments, the MPD may comprise further information relating to the number of source symbols “noSym”.

In case of segments of substantial same duration further information regarding file-size and/or number of symbols is required. This information may be provided in a header, e.g. as a LCT header extension.

Depending on the required degree of robustness, this header may be provided once at the beginning or it may be provided several times within the delivery.

According to still another embodiment an updated Manifest file MPD is provided for reception thereby increasing robustness and allowing for updates.

In another embodiment of the invention it may be foreseen that the Manifest file MPD comprises a plurality of indications of media segments offering different bitrates and/or different resolution and/or different frame rates. In doing so, the benefits of Dynamic Adaptive Streaming over HTTP (DASH) may be achieved.

Although described with respect to particular embodiments, the invention may be employed in a variety of scenarios, including broadcast, multicast and unicast environments. As such the invention may not only be used within a bidirectional communication system but also in unidirectional communication systems such as broadcast systems for digital video and/or digital audio broadcast systems.

The particular combinations of elements and features in the above detailed embodiments are exemplary only; the interchanging and substitution of these embodiments with other embodiments disclosed herein are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

2. Method for providing a media stream, whereby the media stream is segmented in a plurality of consecutive segments,
providing a Manifest file, whereby the Manifest file
comprises an indication of media segments in a URI template manner,
comprises a start index referencing a first segment of said media stream,
whereby the Manifest file allows for assembling from the received Manifest file different URIs,
whereby an assembled URI references a segment of said plurality of segments,
whereby assembling is based on said indication and an index,
whereby the index is calculated on basis of the start index and is incremented by a predetermined value for each consecutive segment,
providing said segments by means of the assembled URIs, whereby providing is based on an identifier allowing for identifying packets of a same segment, whereby said segments are spread over a plurality of packets and each packet of a particular segment comprises said identifier, whereby the index is mapped to the identifier, thereby allowing for a reassembling said segments to form said media stream.

3. Method according to claim 1 or 2, whereby the index is a Transport Object Identifier.

4. Method according to claim 1 or 2 or 3, whereby the Manifest file comprises an end index.

5. Method according to any preceding claim, whereby the stream is provided in a unicast or broadcast or multicast manner.

6. Method according to any preceding claim, whereby the segments are of substantial same size and/or of substantial same duration.

7. Method according to any preceding claim, whereby an updated Manifest file is provided for reception.

8. Method according to any preceding claim, whereby the Manifest file comprises a plurality of indications of media segments offering different bitrates and/or different resolution and/or different frame rates.

9. Apparatus allowing for performing a method according to one of claims 1 to 8.
